(19) United States
(12) Patent Application Publication
(10) Pub. No.: US 2010/0317383 A1
(43) Pub. Date: Dec. 16, 2010

(54) METHOD OF OPTIMAL DATA TRANSMISSION FOR IMPROVING DATA TRANSMISSION RATE IN MULTI-HOP WIRELESS NETWORK

(76) Inventors: Hyun Lee, Daejon (KR); Chang-Sub Shin, Daejon (KR); June Hwang, Gyeonggi-do (KR); Seong-Lyun Kim, Seoul (KR)

Correspondence Address: STAAS & HALSEY LLP, SUITE 700, 1201 NEW YORK AVENUE, N.W., WASHINGTON, DC, 20005, US

(21) Appl. No.: 12/518,013

(22) PCT Filed: Dec. 5, 2007
(86) PCT No.: PCT/KR07/06289

§ 371 Date: Jun. 5, 2009

(30) Foreign Application Priority Data
Dec. 7, 2006 (KR) 10-2006-0124027
Oct. 25, 2007 (KR) 10-2007-0107682

(51) Int. Cl. H04B 15/00; H04B 7/00

(52) U.S. Cl. 455/501; 455/522

(57) ABSTRACT

There is provided a method for optimal data transmission for improving a data transmission rate of a node with variable transmission power in a multi-hop wireless network, the method including the steps of: obtaining channel state information about a current wireless channel of the node; calculating a carrier sensing range in the number of hops using the obtained channel state information, a target signal-to-interference ratio, and a contention window size in order to minimize data collision; calculating the number of nodes attempting data transmission based on signals received from neighbor nodes, the number of the nodes attempting data transmission being the number of contention nodes; and setting transmission power adaptively according to the calculated carrier sensing range value and the contention node numbers and transmitting data with the set of transmission power.

### TECHNICAL FIELD

The present invention relates to a method of optimal data transmission for improving a data transmission rate in a multi-hop wireless network; and, more particularly, to a method of optimal data transmission for improving a data transmission rate in a multi-hop wireless network, which can minimize a data collision and maximize an end-to-end throughput by adaptively calculating a carrier sensing range value for a node with variable transmission power to control the transmission power according to the calculated carrier sensing range value and by adaptively adjusting a carrier sensing threshold value for a node with constant transmission power.

### BACKGROUND ART

There is no prior patent technology related to a method of modifying a physical carrier sensing range in an ad-hoc network. Some related papers are published in the journals and Proceedings of IEEE Communication Society, but such papers also have little relation with the present invention.

In IEEE 802.11 communication standards called Local Area Network (LAN), each terminal (i.e., a node) and an access point (AP) might use the same frequency band. In that case, the terminal (node) and the access point (AP) can recognize each other as one network member to communicate data and control packets with each other.

There are two modes in the IEEE 802.11 standards. One is an infrastructured mode that allows communication between an access point (AP) and a general node but does not allow direct communication between nodes. The other is an ad-hoc mode that allows nodes to communicate data with each other without using a medium connected to a network backbone such as an access point (AP).

The above two modes use Medium Access Control (MAC) methods based on a Carrier Sense Multiple Access/Collision Avoidance (CSMA/CA) scheme, in order to avoid the data collision at a reception node that may occur a wireless medium is shared.

The CSMA/CA scheme uses two carrier sensing modes: a physical carrier sensing mode and a virtual carrier sensing mode.

For transmission of data from a node A to another node, the physical carrier sensing mode checks whether another transmission is performed on a medium before transmitting data from a network interface card (NIC) of the node A. Ready-To-Send (RTS) and Clear-To-Send (CTS) control packets are exchanged to avoid data collision, thereby solving hidden problems that may occur in the network.

Such control packets are also used in the virtual carrier sensing mode. Upon receipt of such control packet, neighbor nodes detect the inhibition of network access for a predetermined time from a Network Allocation Vector (NAV) contained in the received control packet. This is a medium access control method using the virtual carrier sensing mode.

In general, every IEEE 802.11 network interface card uses the physical carrier sensing mode mandatorily and uses a control packet for collision avoidance optionally.

Even though medium access control is performed, simultaneous medium access may occur in a predetermined time point, which leads to data collision. In this case, a node experiencing the data collision waits for a selected number of times within a predetermined range of times and then accesses the medium for data transmission. Such a collision resolution method uses a random backoff scheme.

If a predetermined range of times increase twice for every collision, this case is called Binary Exponential Backoff (BEB). In this case, the number of time slots in a contention window increases twice for every collision from an initial contention window, and a predetermined number of time slots are selected among them. Thus, a node waits for the corresponding time and then accesses a medium. These processes are repeated to solve the collision problem.

Meanwhile, a physical carrier sensing range may be relatively increased in order to minimize a data collision. In this case, simultaneous-transmission nodes are spaced apart from each other. Thus, the power of interference between transmission nodes can be reduced and the probability of the success of data transmission through each link can be increased. However, more intermediate nodes are required in a relay network arranged in linear topology. Thus, a carrier sensing range must be set to be suitable for the trade-off between the above advantage and disadvantage.

Meanwhile, a target SIR of a network interface card may affect data transmission. If the target SIR is set to be high, a relatively large amount of data can be transmission by one successful transmission process, but the data collision probability may increase. Therefore, a target SIR must be set to be suitable for the trade-off between the above advantage and disadvantage.

### DISCLOSURE

### Technical Problem

An embodiment of the present invention is directed to providing a method of optimal data transmission for improving a data transmission rate in a multi-hop wireless network, which can maximize an end-to-end throughput by minimizing a data collision that may occur during data transmission.

Another embodiment of the present invention is directed to providing a method of optimal data transmission for improving a data transmission rate in a multi-hop wireless network, which can minimize a data collision and maximize an end-to-end throughput by calculating a carrier sensing range value for a node with variable transmission power and by controlling the transmission power according to the calculated carrier sensing range value or by adaptively adjusting a carrier sensing threshold value for a node with constant transmission power.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for optima data transmission for improving a data transmission rate of a node with variable transmission power in a multi-hop wireless network, the method including the steps of: obtaining channel state information about a current wireless channel of the node; calculating a carrier sensing range in the number of hops using the obtained channel state information, a target signal-to-interference ratio, and a contention window size in order to minimize data collision; calculating the number of nodes attempting data transmission based on signals received from neighbor nodes, the number of the nodes attempting data transmission being the number of contention nodes; and setting transmission power adaptively according to the calculated carrier sensing range value and the contention node numbers and transmitting data at the set transmission power.

In accordance with another aspect of the present invention, there is provided a method for optima data transmission for improving a data transmission rate of a node with constant transmission power in a multi-hop wireless network, the method including the steps of: obtaining channel state information about a current wireless channel of the node; setting a carrier sensing threshold using the obtained channel state information, a target signal-to-interference ratio, the constant transmission power, and a contention window size in order to minimize data collision; and comparing the carrier sensing threshold with the reception power of a signal received from a neighbor node, determining whether to transmit data according to the comparison results, and transmitting data accordingly.

### ADVANTAGEOUS EFFECTS

If mobile nodes (e.g., cars and vehicles) equipped with IEEE 802.11 network interface card are arranged in linear topology, when a source node is to transmit data through intermediate relay nodes to a destination node, the present invention adjusts the relative distance or the carrier sensing threshold of the simultaneous-transmission nodes to adjust the strength of the interference power received by each reception node, thereby making it possible to maximize an end-to-end throughput.

The present invention adaptively calculates a carrier sensing range value for a node with variable transmission power, thereby making it possible to minimize a data collision and maximize an end-to-end throughput. Also, the present invention adaptively adjusts a carrier sensing threshold value for a node with constant transmission power, thereby making it possible to minimize a data collision and maximize an end-to-end throughput.

### DESCRIPTION OF DRAWINGS

FIG. 1 is a diagram illustrating the distribution of simultaneous transmission nodes in a multi-hop wireless network to which the present invention is applied.

FIG. 2 is a flowchart illustrating a method for optimal data transmission from a node with variable transmission power on a multi-hop wireless network in accordance with an embodiment of the present invention.

FIG. 3 is a flowchart illustrating a method for optimal data transmission from a node with constant transmission power on a multi-hop wireless network in accordance with an embodiment of the present invention.

FIG. 4 is a graph illustrating the relationship between a target SIR and a carrier sensing threshold.

FIG. 5 is a graph illustrating the relationship between a target SIR and an end-to-end throughput.

### BEST MODE

The advantages, features and aspects of the invention will become apparent from the following description of the embodiments with reference to the accompanying drawings, which is set forth hereinafter.

Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

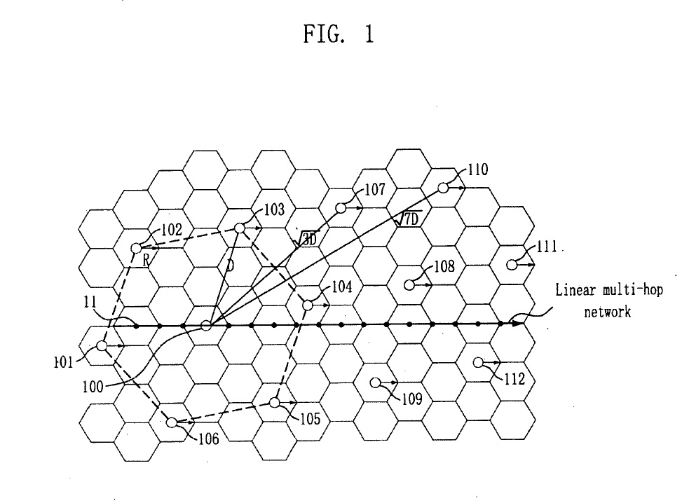

FIG. 1 is a diagram illustrating the distribution of simultaneous transmission nodes in a multi-hop wireless network to which the present invention is applied.

FIG. 1 is drawn on the assumption that nodes on the multi-hop wireless network are located at regular intervals at the vertexes and centers of hexagons. That is, a reference numeral 10 denotes a linear multi-hop wireless network where nodes 11 are linearly distributed along a road. A reference symbol R denotes the radius of a hexagon and a reference symbol D denotes the shortest simultaneous transmission distance.

In FIG. 1, small black dots 11 denote nodes that are distributed on the road represented by a thick straight line. The node is mounted on a mobile unit, uses a half-duplex scheme, and may have an omni-directional antenna. Hereinafter, the term ‘node’ denotes a mobile unit mounted with a terminal.

In FIG. 1, circles 100 to 112 also denote nodes, which represent the distribution of nodes capable of performing simultaneous transmission without affecting data transmission therebetween. The nodes 100 to 112, which are spaced apart from each other by at least the distance D, are capable of simultaneous transmission.

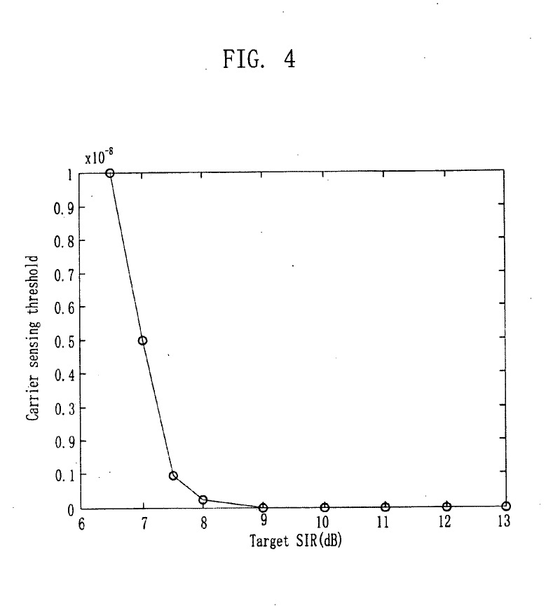

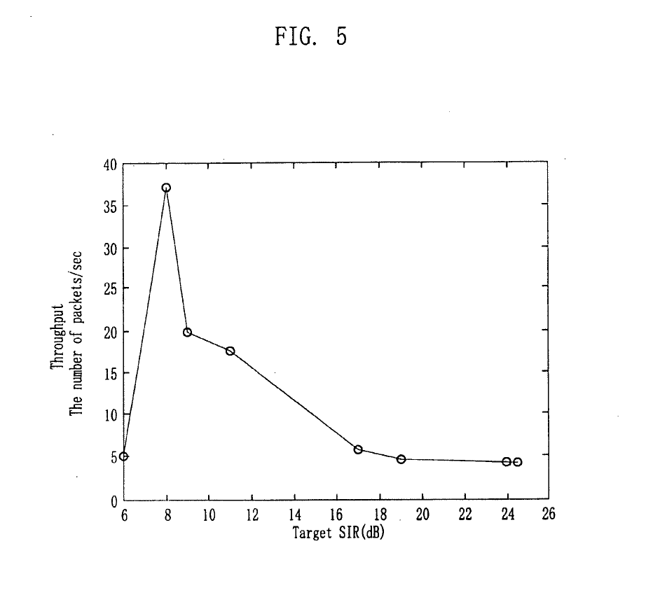

The above linear distribution of the nodes is merely illustrative, which is merely to perform simulations (see FIGS. 4 and 5) with ease. The present invention can also be applied even when the nodes are nonlinearly distributed.

The present invention provides methods for optimal data transmission in a multi-hop wireless network, which may be implemented in the following two schemes.

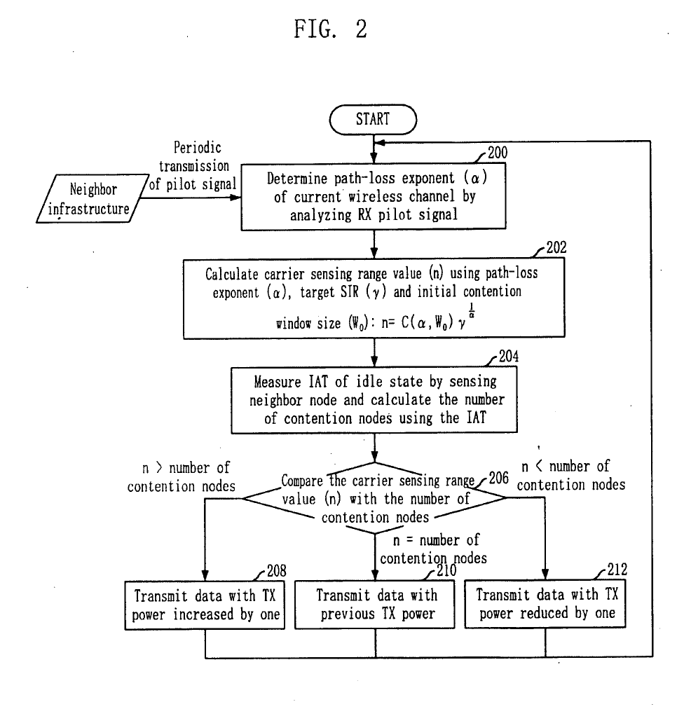

One is a scheme applied to a node with ‘variable’ transmission power, which detects the optimal ‘carrier sensing range’ value (see Equation 1 below), compares the detected value with an idle state Inter-Arrival Time (IAT) of the current transmission medium (wireless section), and obtains the desired performance by adaptively adjusting the transmission power according to the comparison results (see FIG. 2). Also, this scheme is distributive and is thus easy to apply to actual mobile environments.

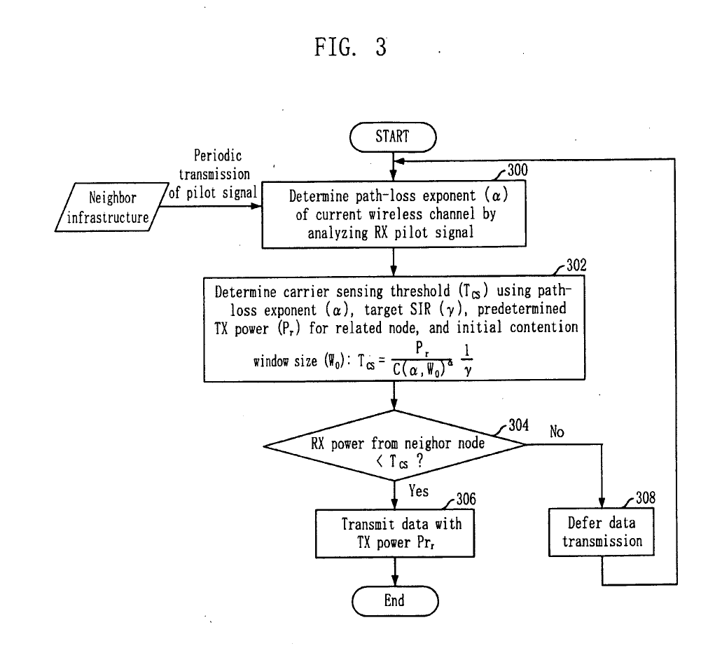

Another is a scheme applied to a node with ‘constant’ transmission power, which obtains the desired performance by adjusting the ‘carrier sensing threshold’ (see Equation 6 below) of a network interface card (see FIG. 3).

In general, a target SIR for a node is provided from an application level. If the node can determine a target SIR value randomly, it may calculate a target SIR of the maximum performance by using given parameters.

Hereinafter, the above schemes will be described in detail with reference to FIGS. 2 and 3.

FIG. 2 is a flowchart illustrating a method for optimal data transmission from a node with variable transmission power on a multi-hop wireless network in accordance with an embodiment of the present invention, which illustrates a data transmission process performed by each node with variable transmission power.

The optimal carrier sensing range n will be described first before describing a data transmission method with reference to FIG. 2.

The optimal carrier sensing range n used for transmission power control is calculated based on the following Equation 1.

$$n = C ( α , {W}_{0} ) {γ}^{\frac{1}{α}} \qquad Eq . 1$$

where n denotes the optimal carrier sensing range, which is represented by “Number of Hops” as n=D/R. If n is an integer, simultaneous transmission is performed at another node spaced apart by n hops. If n is not an integer, simultaneous transmission is performed at the position spaced apart by (the smallest integer greater than n) (i.e., (the integer portion of n)+1) hops. C(α,W₀) is the solution of a fourth-order polynomial found from a path-loss exponent α and an initial contention window size W₀. γ denotes a target Signal-to-Interference Ratio (SIR).

Hereinafter, the way to find the solution C(αW₀) will be described in detail.

Assume that nodes (i.e., mobile units) on a road forms linear topology and that the other nodes are distributed very densely, as illustrated in FIG. 1. In this case, when a node performs data transmission, the other nodes within the corresponding carrier sensing range cannot perform data transmission. Thus, a plurality of nodes must be spaced apart from each other by at least the distance D (i.e., at least n hops) so that they are capable of simultaneous transmission. Also, because of the distribution with a sufficiently high density, the relative positions of nodes in a transmission mode have the same form as the positions of co-channel base stations of the hexagonal cellular system.

Thus, an RX SIR γ,(P) of an RX node located at one vertex of a hexagon (e.g., a hexagon formed by nodes 101 to 106) in FIG. 1 can be calculated based on the following Equation 2. That is, Equation 2 represents an SIR γ,(P) of a signal received at a node i (i.e., RX node) 100 located at the center of the hexagon formed by the nodes 101 to 106.

$${γ}_{i} ( P ) = \frac{\frac{{X}_{i}}{{R}^{α}}}{{\sum }_{j = 1}^{6} \frac{{Y}_{j}}{{D}^{α}} + {\sum }_{k = 7}^{12} \frac{{Y}_{k}}{{( \sqrt{3} D )}^{α}} + {\sum }_{l = 13}^{18} \frac{{Y}_{l}}{{( 2 D )}^{α}} + …} \qquad Eq . 2$$

where Xᵢ, Yⱼ, Yₖ, Yₗ, . . . are random variables of an independent and identical distribution with an average value of 1.

If the SIR γ,(P) of the RX signal calculated by Equation 2 is larger than a predetermined target SIR γ, a wireless link is connected successfully. If not, i.e., if the SIR γ,(P) of the RX signal calculated by Equation is not larger than a predetermined target SIR γ, a transmission failure occurs and a retransmission is performed after a predetermined time by the binary exponential random backoff of medium access control. Herein, the probability of failure of one wireless link, i.e., the wireless link failure probability P_{c} can be calculated based on the following Equation 3.

$${P}_{c} = Pr [ {γ}_{i} ( P ) \leq γ ] = 1 - \frac{1}{2} {e}^{\frac{1}{2} γ ( - 2 u + {v}^{2} γ )} \cdot erfc ( \frac{- u + {v}^{2} γ}{\sqrt{2} v} ) \qquad Eq . 3$$

where if α=4, then

$$u = 7 {( \frac{R}{4} )}^{4} = 7 {( \frac{1}{n} )}^{4} , v = 2.5 {( \frac{R}{D} )}^{4} = 2.5 {( \frac{1}{n} )}^{4} .$$

Also, u,v are represented by the carrier sensing range n by using the relationship

$$n = \frac{D}{R} .$$

Also, γ denotes a target SIR.

According to the paper [B.-J. Kwak, N.-O. Song and L. E. Miller, Performance analysis of exponential backoff, IEEE/ACM Trans. Networking, Vol. 13, No. 2, pp. 343-355, 2005], if the collision probability P_{c} is given, the average time N(P_{c}, W₀) delayed due to the system of binary exponential random backoff can be calculated based on the following Equation 4.

$$N ( {P}_{c} , {W}_{0} ) = \frac{1}{2} ( \frac{1}{1 - {P}_{c}} + \frac{{W}_{0}}{1 - 2 {P}_{c}} ) - 1 \qquad Eq . 4$$

where W₀ denotes the initial contention window size used in the binary exponential random backoff system and P_{c} denotes the collision probability.

The average time Δ(γ,n) taken to transmit a packet from a source node to a destination node can be calculated based on the following Equation 5.

$$Δ ( γ , n ) = n \cdot [ \frac{1}{2} ( \frac{1}{1 - {P}_{c}} + \frac{{W}_{0}}{1 - 2 {P}_{c}} ) - 1 ] \cdot {t}_{slot} \qquad Eq . 5$$

where tₛₗₒₜ, denotes the duration of a single slot used in the binary exponential random backoff system.

Because the erfc portion in the wireless link failure probability P_{c} can be approximated to “2”, Equation 3 can be substituted by

$${P}_{c} = 1 - {e}^{\frac{1}{2} γ ( - 2 u + {v}^{2} γ )} .$$

### When

$${P}_{c} = 1 - {e}^{\frac{1}{2} γ ( - 2 u + {v}^{2} γ )}$$

is applied to Δ(65 n) of Equation 5, the average time Δ(γl ) taken to transmit a packet from a source node to a destination node is expressed as a function of γ,n,W₀.

If the target SIR γ is fixed, Δ(γ,n) becomes a concave function of the number n of reuse hops and thus there is the optimal hop number n that minimizes a delay time. In order to calculate the optimal hop number n, the exponential item of P_{c} is set to a variable X and Δ(γ,n) is differentiated to fine a point of “0”. In this case, for the convenience of calculation, an exponential function can be approximated using a Taylor series and up to a fifth-order polynomial equation can be obtained. Arithmetically, a fifth or higher order equation has no general solution and thus cannot be expressed as the closed-form solution. Instead, an iterative tracking scheme can be used with increasing a numerical accuracy. When more terms are omitted in the Taylor series, a fourth or lower order equation can be obtained. However, the accuracy of the obtained solution decreases.

When an X value of a point differentiated to “0” is determined, it is checked whether the determined value satisfies the condition of

$$0 < {P}_{c} < \frac{1}{2} .$$

By doing so, X* satisfying the above condition is obtained finally. Because of the assumption of

$$\frac{1}{2} γ ( - 2 u + {v}^{2} γ ) = {X}^{*}$$

in the intermediate calculation process, when this equation is solved, the optimal reuse hop number (i.e., the number of hops for the optimal carrier sensing range) of

$$n = C ( α , {W}_{0} ) {γ}^{\frac{1}{α}}$$

(see Equation 1) can be obtained.

In brief, the carrier sensing range value n expressed in the hop number (see Equation 1) is the solution of the equation

$$\frac{1}{2} γ ( - 2 u + {v}^{2} γ ) = {X}^{*} .$$

As an example, for W₀=4, C(α,4) has values of 11.59, 3.6, 2.83, 2.03, 1.79 as the path-loss exponent a has values of 2, 3, 4, 5, 6.

Using the target SIR γ and the constants calculated above, the carrier sensing threshold T_{CS}, can be calculated based on the following Equation 6.

$${T}_{CS} = \frac{Pr}{{C ( α , {W}_{0} )}^{α}} \frac{1}{γ} \qquad Eq . 6$$

where Pr denotes transmission power and the remaining factors are the same as described above.

There is a case where a network interface card (i.e., a node) can provide a plurality of target SIRs. In this case, the optimal target SIR can be calculated using given parameters α,W₀,n, T_{CS} as follows:

Assume that there are m target SIRs γ of the network interface card and they are γₙ, {n=1, 2, . . . , m}. The γₙ values vary depending on modulation schemes.

In this manner, one node provides a plurality of target SIRs and simultaneous transmission is performed at the hop of the optimal carrier sensing range obtained above for a specific γₙ. In this case, when data are transmitted at a data transmission rate supportable for the specific γₙ, the throughput satisfying the maximum data transmission rate can be obtained. Because each γₙ value has no uniform relation with a data transmission rate, the γₙ with the maximum throughput can be obtained experimentally.

Even when the optimal carrier sensing range is determined using Equation 1, because the carrier sensing range is determined through a centralized calculation process, the determined carrier sensing range is unreasonable to apply directly to actual nodes (i.e., terminals) of distributed environments. In order to solve this problem, the present invention provides a function for adjusting the transmission power for data transmission.

Hereinafter, the method for optimal data transmission from the node with variable transmission power will be described in detail with reference to FIG. 2.

Referring to FIG. 2, in step S200, a node desiring to transmit data at a predetermined data transmission rate, which includes a source node and a relay node, receives a pilot signal transmitted periodically from a neighbor infrastructure and analyzes the received pilot signal, thereby determining channel state information of the current wireless channel, i.e., a path-loss exponent α. For example, the node analyzes the reception power of a pilot signal received periodically from a neighbor infrastructure (e.g., devices located on a road and transmit a busy tone or a pilot signal), determines the current channel state (e.g., whether a line-of-site environment or an environment with many reflective objects), and determines a path-loss exponent α as one of 2 through 6 according to the status determination results.

In the above-described embodiment, a path-loss exponent α is obtained by analyzing a pilot signal received periodically from a neighbor infrastructure. In an alternative embodiment, a path-loss exponent α is obtained by analyzing signals received from neighbor nodes.

In step S202, the node calculates a carrier sensing range n, which is capable of minimizing data collision, according to Equation 1 using a path-loss exponent α, a target SIR γ, and an initial contention window size W₀. That is, assuming that Wₒ of

$$n = C ( α , {W}_{0} ) {γ}^{\frac{1}{α}}$$

(see Equation 1) is “4” (may be different in actuality), C(α,4) has values of 11.59, 3.6, 2.83, 2.03, 1.79 as a path-loss exponent α has values of 2, 3, 4, 5, 6. Thus, when W₀=4 and the path-loss exponent α determined in step S200 are substituted, the carrier sensing range n becomes one of 11.59, 3.6, 2.83, 2.03, 1.79. Herein, the target SIR γ is calculated and provided by an application program of the corresponding node, which is set to be optimal based on a data transmission rate supportable by a network interface card.

Thereafter, the node senses neighbor nodes and measures an idle state Inter-Arrival Time (IAT). That is, when there is data to be transmitted, each node checks the time of an idle state of a propagation environment (e.g., a wireless transmission medium) to detect a time interval between idle states.

In step S204, using the idle state IAT, the node calculates the number of nodes attempting data transmission (hereinafter referred to as contention node number) based on the following Equation 7. In step S206, the node compares the calculated contention node number with the carrier sensing range n.

$$Number of Contention Nodes = \frac{IAT}{K} + 1 \qquad Eq . 7$$

where K denotes a transmission slot time of a node on the multi-hop wireless network. If K and the idle state IAT both have the time unit of seconds, the contention node number can be compared with the carrier sensing range n.

If the carrier sensing range n is larger than the contention node number, the node increases the previous transmission power by one level and transmits data at the increased transmission power, in step S208.

If the carrier sensing range n is equal to the contention node number, the node maintains the previous transmission power and transmits data at the maintained transmission power, in step S210.

If the carrier sensing range n is smaller than the contention node number, the node reduces the previous transmission power by one level and transmits data at the reduced transmission power, in step S212.

The above processes are repeated to transmit data at the optimal transmission power.

FIG. 3 is a flowchart illustrating a method for optimal data transmission from a node with constant transmission power on a multi-hop wireless network in accordance with an embodiment of the present invention.

In general, an IEEE 802.11 node, specifically a network interface card of the node has a constant carrier sensing threshold. If the network interface card is improved to correct the carrier sensing threshold, the optimal carrier sensing threshold can be determined using a suitable calculation scheme. Also, if each node NIC sets a target SIR according to a supportable target data transmission rate, calculates an optimal carrier sensing threshold using the target SIR, and determines whether to transmit data according to the optimal carrier sensing threshold, the maximum throughput can be obtained.

Referring to FIG. 3, in step S300, a node desiring to transmit data at a predetermined data transmission rate, i.e., a node with constant transmission power, receives a pilot signal transmitted periodically from a neighbor infrastructure and analyzes the received pilot signal, thereby determining channel state information of the current wireless channel, i.e., a path-loss exponent α. A detailed description of this is the same as that in FIG. 2.

In step S302, the node calculates a carrier sensing threshold T_{CS}, which is capable of minimizing data collision, based on Equation 6 using a path-loss exponent α, a target SIR γ, a predetermined transmission power Pr, and an initial contention window size W₀. Herein, the target SIR γ is calculated and provided by an application program of the corresponding node, which is set to be optimal based on a data transmission rate supportable by a network interface card.

Thereafter, the node senses neighbor nodes and measures an idle state Inter-Arrival Time (IAT). That is, when there is data to be transmitted, each node checks the time of an idle state of a propagation environment (e.g., a wireless transmission medium) to detect a time interval between idle states.

In step S304, the node compares the reception power of a signal received from a neighbor node with the carrier sensing threshold T_{CS}.

If the signal reception power is smaller than the carrier sensing threshold T_{CS}, the node transmits data with the predetermined transmission power Pr, in step S306.

If the signal reception power is larger than or equal to the carrier sensing threshold T_{CS}, the node defers data transmission in step S308 and returns to step S300. The reason for this is that when sensing the reception power higher than the carrier sensing threshold T_{CS}, through a network interface card, the node knows that it should not transmit data because another node is transmitting data through a wireless medium (e.g., a wireless channel).

FIG. 4 is a graph illustrating the relationship between a target SIR and a carrier sensing threshold. FIG. 5 is a graph illustrating the relationship between a target SIR and an end-to-end throughput.

The simulation for the present invention is an experiment that arranges 15 nodes linearly and detects the relationship between the target SIR and the optimal carrier sensing threshold.

The constant C (see Equation 1) may be different from the simulation result. The reason for this is that all parameters of actual conditions are not considered in the present simulation.

The present simulation disregards constants and focuses on detecting the degree of the similarity of the equation structure to the simulation. The simulation exhibits the satisfactory similarity to actual conditions.

A threshold value for determination of the carrier sensing range is present in a network interface card of each node, and the carrier sensing range may be considered as being reciprocal to the threshold value. Thus, FIG. 4 shows that the carrier sensing range n and the target SIR γ have a relationship of about n=C(α,W₀)γ^{1/α}. If the constant C is considered as a random value, only the product forms can be seen.

FIG. 5 shows end-to-end throughput values (i.e., network throughput values) depending on the target SIRs in the graph of FIG. 4. It can be seen from FIG. 5 that the maximum throughput “30” is obtained when the target SIR is 8 dB.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application Nos. 2006-0124027, and 2007-0107682, filed in the Korean Intellectual Property Office on Dec. 7, 2006, and Oct. 25, 2007, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for optimal data transmission for improving a data transmission rate of a node with variable transmission power in a multi-hop wireless network, the method comprising:
obtaining channel state information about a current wireless channel of the node;
calculating a carrier sensing range in the number of hops using the obtained channel state information, a target signal-to-interference ratio, and a contention window size in order to minimize data collision;
calculating the number of nodes attempting data transmission based on signals received from neighbor nodes, the number of the nodes attempting data transmission; and
setting a transmission power adaptively according to the calculated carrier sensing range value and the contention node numbers and transmitting data with the set of transmission power.

2. The method of claim 1, wherein obtaining the channel state information includes obtaining a pass-loss exponent on a wireless channel by analyzing a pilot signal received periodically from a infrastructure of the multi-hop wireless network adjacent to the node.

3. The method of claim 1, wherein obtaining the channel state information includes obtaining a pass-loss exponent on a wireless channel by analyzing signals received from the neighbor nodes.

4. The method of claim 1, wherein the target signal-to-interference ratio is set based on a data transmission rate supportable by a network interface card of the node.

5. The method of claim 1, wherein transmitting the data includes:
comparing the calculated carrier sensing range value with the contention node number;
transmitting data at transmission power higher than the previous transmission power if the carrier sensing range value is larger than the contention node number;
transmitting data at transmission power equal to the previous transmission power if the carrier sensing range value is equal to the contention node number; and
transmitting data at transmission power lower than the previous transmission power if the carrier sensing range value is smaller than the contention node number.

6. The method of claim 5, wherein the contention node number is calculated by obtaining an idle state inter-arrival time from the signals received from the neighbor nodes and dividing the idle state inter-arrival time by a transmission slot time of the node on the multi-hop wireless network.

7. A method for optima data transmission for improving a data transmission rate of a node with constant transmission power in a multi-hop wireless network, the method comprising:
obtaining channel state information about a current wireless channel of the node;
setting a carrier sensing threshold using the obtained channel state information, a target signal-to-interference ratio, the constant transmission power, and a contention window size in order to minimize data collision; and
comparing the carrier sensing threshold with the reception power of a signal received from a neighbor node, determining whether to transmit data according to the comparison results, and transmitting data accordingly.

8. The method of claim 7, wherein obtaining the channel state information includes obtaining a pass-loss exponent on a wireless channel by analyzing a pilot signal received periodically from a infrastructure of the multi-hop wireless network adjacent to the node.

9. The method of claim 7, wherein obtaining the channel state information includes obtaining a pass-loss exponent on a wireless channel by analyzing signals received from the neighbor nodes.

10. The method of claim 7, wherein the target signal-to-interference ratio is set based on a data transmission rate supportable by a network interface card of the node.

11. The method of claim 7, wherein transmitting the data includes:
comparing the carrier sensing threshold with the reception power of the signal received from the neighbor node;
transmitting data at the constant transmission power if the reception power of the signal received from the neighbor node is smaller than the carrier sensing threshold; and
returning to the channel state information obtaining step without performing data transmission if the reception power of the signal received from the neighbor node is larger than or equal to the carrier sensing threshold.
